(19) United States
(12) Patent Application Publication
(10) Pub. No.: US 2008/0201958 A1
(43) Pub. Date: Aug. 28, 2008

(54) HOSE SHEARING DEVICE

(76) Inventor: Jerold T. Herman, Woodville, OH (US)

Correspondence Address: FRASER CLEMENS MARTIN & MILLER LLC, 28366 KENSINGTON LANE, PERRYSBURG, OH, 43551, US

(21) Appl. No.: 12/037,259

(22) Filed: Feb. 26, 2008

Related U.S. Application Data
(60) Provisional application No. 60/891,625, filed on Feb. 26, 2007.

(51) Int. Cl. B26B 11/00

(52) U.S. Cl. 30/131

(57) ABSTRACT

A shearing device is disclosed that encloses a cutting member for user safety, and that allows the cutting member to be quickly and easily replaced, the shearing device including a cutting member removably coupled to a mount and disposed in a housing, wherein the mount is coupled to an actuator, and wherein the shearing device is adapted to minimize an amount of waste material sheared from a hose.

### CROSS-REFERENCE TO RELATED APPLICATION

This application claims the benefit of Provisional Patent App. No. 60/891,625 filed Feb. 26, 2007.

### FIELD OF THE INVENTION

The invention relates to a shearing device and more particularly to a shearing device for cutting a hose including a mount and a cutting member which cooperate to facilitate efficient changing of the cutting member.

### BACKGROUND OF THE INVENTION

Shearing devices generally employ a blade or other cutting member disposed perpendicular to a longitudinal axis of a hose or other work-piece to be sheared. The hose is secured to militate against twisting or shifting during a shearing operation to avoid uneven, ragged, and misdirected cuts. Further, if an end of the hose must be sheared to form a smooth edge, an amount of hose must be sheared off as waste. To militate against a deformation of the end of the hose by a force caused by the cutting member of the shearing device, the amount of hose sheared off as waste is typically a length of about one and a half times an inner diameter of the hose. The amount of waste hose sheared may be costly depending upon the materials used to form the hose and the amount of hose cut.

Known shearing devices have relied on complicated or cumbersome means to secure the hose during the shearing operation such as vices, clamps, and other means for securing. Other known shearing devices include a hose disposed in a curved or grooved surface formed in the device. A force caused by the cutting member of the device on the hose causes the hose to be held in position in the curve or grooved surface during a shearing operation. However, during the shearing operation the hose may deform and move upwardly from the curved or grooved surface, thereby resulting in an uneven cut.

Typical shearing devices also may have problems with damage to the cutting member. Many shearing devices allow the blade to flex or bend within the device, thereby resulting in increased stress and damage to the cutting member that may shorten the useful life thereof. Further, when the cutting member must be replaced, typical shearing devices require a complete disassembly of the device to facilitate replacement thereof. Many known shearing devices couple the blade to the shearing device with screws or pins requiring a user to manually disengage the screws or pins to replace the cutting member. Also, many known shearing devices require a user to manually reach into the device to position the hose or to remove sheared waste hose, thereby risking accidental contact with the cutting member.

It is desirable to produce a shearing device adapted to minimize an amount of waste material sheared from a hose, that encloses a cutting member for user safety, and that allows the cutting member to be quickly and easily replaced.

### SUMMARY OF THE INVENTION

A shearing device has surprisingly been discovered that is adapted to minimize an amount of waste material sheared from a hose, that encloses a cutting member for user safety, and that allows the cutting member to be quickly and easily replaced.

In one embodiment, a hose shearing device comprises a housing adapted to receive a portion of a hose therein; a mount slidably disposed in said housing; a cutting member releasably mounted to said mount; an actuator operatively coupled to said mount to slidably move said mount in said housing and cause said cutting member to engage the hose; a retainer removably coupled to said mount to facilitate removal of said cutting member.

In another embodiment, a hose shearing device comprises a housing including a nest adapted to receive a portion of a hose therein; a mount slidably disposed in said housing; a cutting member releasably mounted to said mount; an actuator operatively coupled to said mount to slidably move said mount in said housing and cause said cutting member to engage the hose; a retainer removably coupled to said mount, wherein said retainer militates against removal of said cutting member when said guide is coupled to said mount and facilitates removal of said cutting member when removed from said mount.

In another embodiment, A hose shearing device comprises a housing including a nest adapted to receive a portion of a hose therein; a mount slidably disposed in said housing; a cutting member having a cutting edge forming a first bevel and a second bevel releasably mounted to said mount; an actuator operatively coupled to said mount to slidably move said mount in said housing and cause said cutting member to engage the hose; a retainer removably coupled to said mount, wherein said retainer militates against removal of said cutting member when said guide is coupled to said mount and facilitates removal of said cutting member when removed from said mount.

### BRIEF DESCRIPTION OF THE DRAWINGS

The above and other objects and advantages of the invention will become readily apparent to those skilled in the art from reading the following detailed description of the invention when considered in the light of the accompanying drawings, in which:

FIG. 1 is a perspective view of a shearing device with a side of a housing removed in accordance with an embodiment of the invention;

FIG. 2 is an exploded perspective view of the shearing device of FIG. 1 including both sides of the housing;

FIG. 3 is a perspective view of a nest of the shearing device of FIG. 1;

FIG. 4 is a perspective view of a cutting member mount of the shearing device of FIG. 1;

FIG. 5 is a side elevational view of a cutting member of the shearing device of FIG. 1; and

FIG. 6 is a top plan view of the cutting member of FIG. 5 including an enlarged view of a cutting edge of the cutting member.

### DETAILED DESCRIPTION OF THE PREFERRED EMBODIMENTS OF THE INVENTION

The following detailed description and appended drawings describe and illustrate various exemplary embodiments of the invention. The description and drawings serve to enable one skilled in the art to make and use the invention, and are not intended to limit the scope of the invention in any manner.

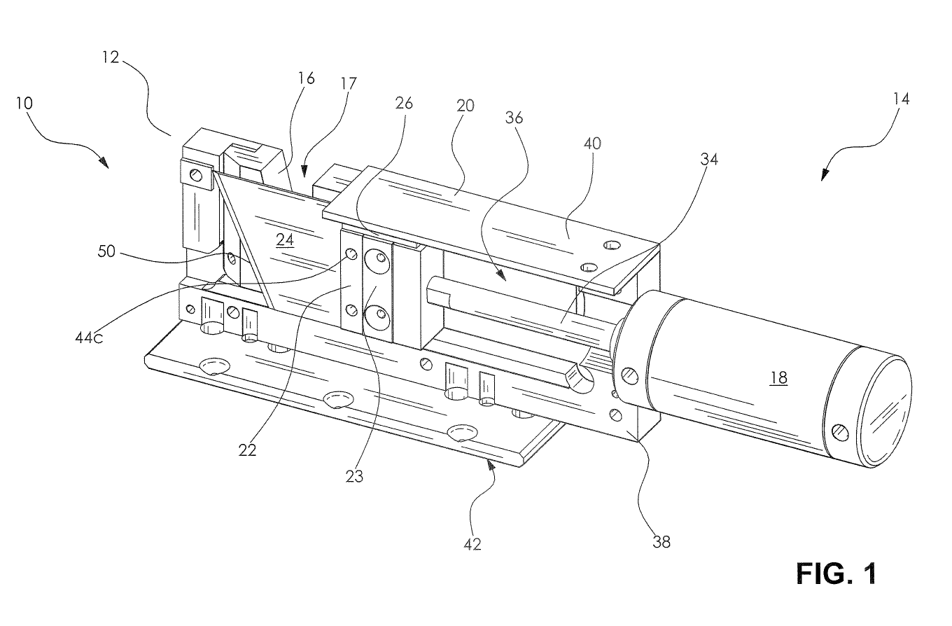

Referring to FIG. 1, there is illustrated a shearing device 10 for cutting a hose (not shown) or other conduit, such as hoses and conduits used in automotive applications, for example. It is understood that the hose may be formed from a plastic, a metal, or any other conventional material capable of being sheared. The shearing device 10 includes a pair of nests 16, an actuator 18, a housing 20, a cutting member mount 22, a cutting member 24, and a retainer 26.

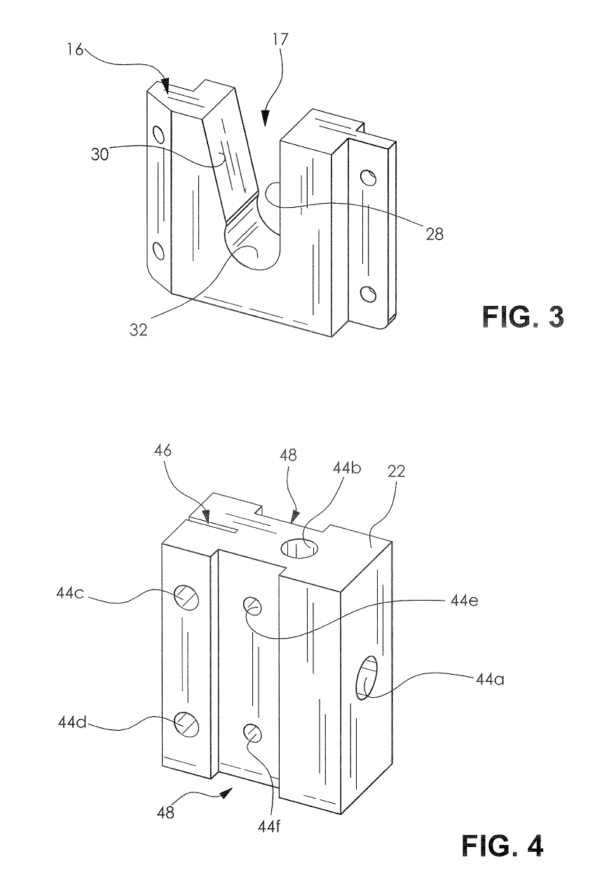

As shown in FIGS. 1-3, each of the nests 16 include an aperture 17 formed by a substantially vertical edge 28, an angled edge 30, and a curvilinear edge 32 adapted to receive a portion of the hose. The nests 16 are disposed adjacent a first end 12 of the shearing device 10. One of the nests 16 is coupled to a first body half 38 of the housing 20, and another of the nests 16 is coupled to a second body half 39 of the housing 20. It is understood that the shearing device 10 may include a single nest 16, or the nests 16 may be integrally formed with the body halves 38, 39, as desired. In the embodiment shown, the curvilinear edges 32 of the nests 16 form an arc greater than 180° to militate against an upward movement of the hose when the hose is disposed in the nests 16. The arcs formed by the circular edges 32 may be any angles, as desired. It is understood that the curvilinear edges 32 may have any shape as desired. It is further understood that the vertical edges 28 may be angled, and that the angled edges 30 may be disposed at any angle in respect of vertical, as desired.

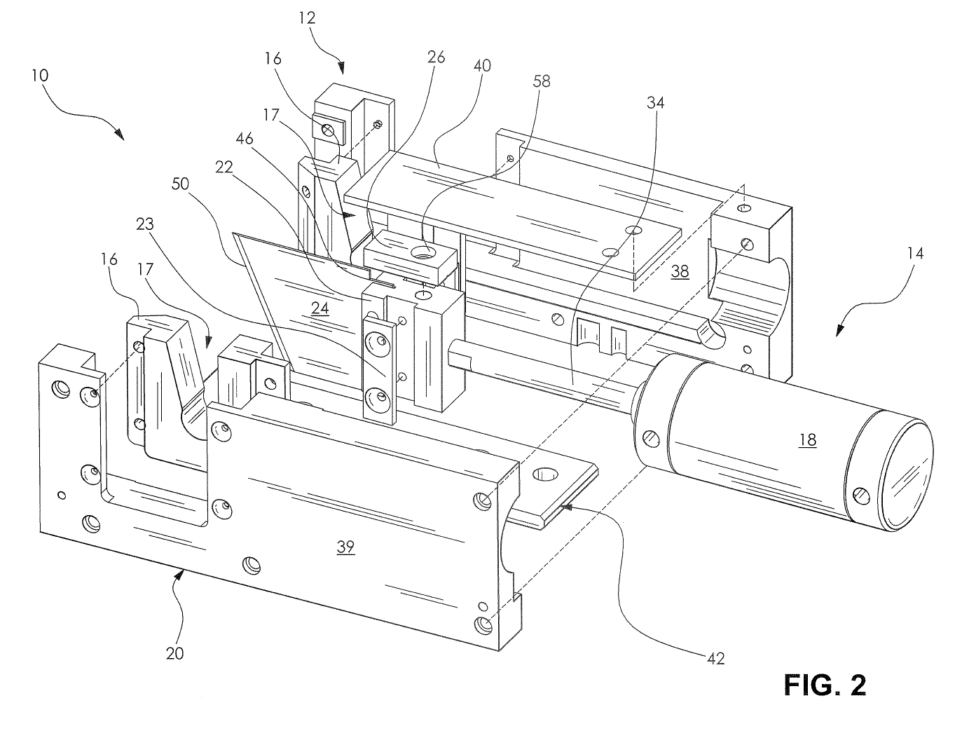

The actuator 18 includes an actuator arm 34. In the embodiment shown in FIGS. 1 and 2, the actuator 18 is disposed at a second end 14 of the shearing device 10. The actuator 18 is releasably coupled to the housing 20 with the actuator arm 34 disposed in a hollow interior 36 of the housing 20. In the embodiment shown, the actuator 18 is a pressure cylinder. Any conventional pressure cylinder can be used such as a hydraulic cylinder and a pneumatic cylinder, for example, as well as other driving members such as mechanical or electrical driving members. The actuator 18 is typically in communication with a power source (not shown) and a controller (not shown).

The first body half 38 and the second body half 39 cooperate to form the housing 20. The housing 20 further includes a top plate 40 and a bottom plate 42. The body halves 38, 39 and plates 40, 42 cooperate to form the hollow interior 36. The hollow interior 36 is adapted to receive the actuator arm 34, the mount 22, the retainer 26, and the cutting member 24 therein. The hollow interior 36 may be further adapted to receive the actuator 18 or a portion thereof, as desired. In the embodiment shown, the housing 20 is formed from aluminum and has a substantially rectangular shape. It is understood that the housing 20 may be formed from any conventional material and may have any shape, as desired.

As shown in FIG. 4, the mount 22 includes a plurality of apertures 44a-44f, a slot 46, and a pair of pockets 48. The mount 22 is slidably disposed and fully enclosed within the hollow interior 36 of the housing 20. The aperture 44a is formed in a back edge of the mount 22 and is adapted to receive the actuator arm 34 to couple the mount 22 to the actuator 18. The aperture 44b is formed in a top edge of the mount 22 and is adapted to receive a means for fastening (not shown) to couple the retainer 26 to the mount 22. The slot 46 is formed in a front edge of the mount 22. The slot 46 is disposed on a longitudinal axis of the mount 22 and is substantially vertical. The apertures 44c, 44d are formed through the mount 22 and the slot 46. The aperture 44c and the aperture 44d are formed substantially perpendicular to the slot 46. Each of the apertures 44c, 44d is adapted to receive a pin (not shown).

The pockets 48 formed on side edges of the mount 22 are adapted to receive guides 23, as shown in FIGS. 1 and 2. The guides 23 are coupled to the mount 22 by a means for fastening (not shown) disposed in the aperture 44e and the aperture 44f formed in the side edges of the mount 22. The means for fastening may be a screw, a bolt, a pin, or other conventional fastening device, as desired. The guides 23 may be formed from UHMWPE or other conventional material adapted to resist wear and minimize friction. In the embodiment shown, the mount 22 is formed from aluminum and has a substantially rectangular shape. It is understood that the mount 22 may be formed from any conventional material and may have any shape, as desired.

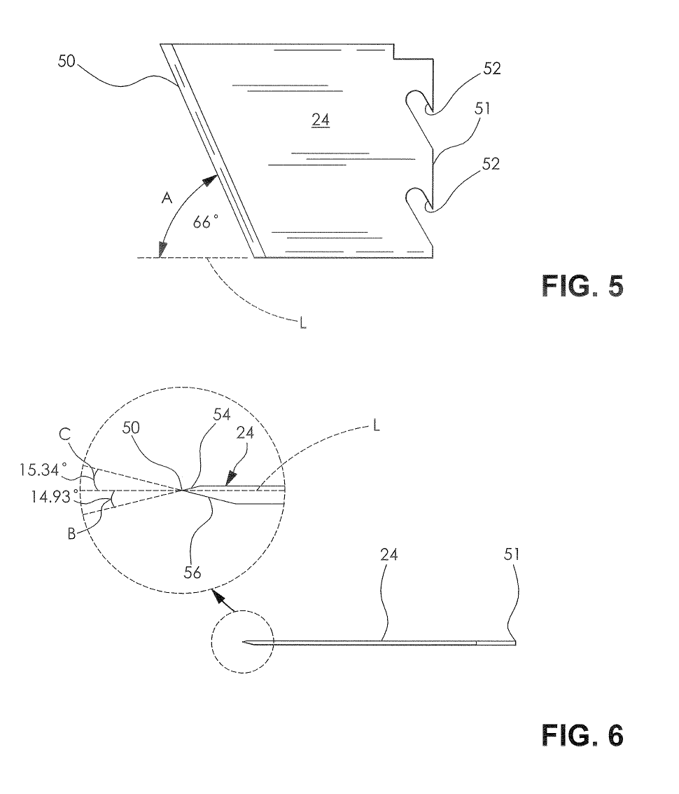

As shown in FIGS. 5 and 6, the cutting member 24 includes a cutting edge 50 and a plurality of apertures 52. The cutting member 24 is coupled to the mount 22. The cutting edge 50 of the cutting member 24 includes a first bevel 54 and a second bevel 56 opposite the first bevel 54. In the embodiment shown, the cutting edge 50 is formed at an angle A of about 66° relative to a longitudinal axis L of the shearing device 10. It is understood that the cutting edge 50 may be formed at other angles relative to the longitudinal axis L, as desired. The first bevel 54 of the cutting edge 50 is formed at an angle B of about 14.9° relative to the longitudinal axis L of the shearing device 10. Favorable results have been obtained with the first bevel 54 having an angle B of about 14.93°. The second bevel 56 is formed at an angle C of about 15.3° relative to the longitudinal axis of the shearing device 10. Favorable results have been obtained with the second bevel 56 having an angle C of about 15.34°. Additionally, in the embodiment shown, the first bevel 54 is shorter in length than the second bevel 56 and is typically disposed adjacent a portion of the hose that will be sheared off as waste. It is understood that the first bevel 54 and the second bevel 56 may be formed at any angles B, C and may have any length or other dimensions, as desired. Also in the embodiment shown, the two apertures 52 are formed in an edge 51 opposite the cutting edge 50. The apertures 52 are formed by a curvilinear distal edge and a pair of linear edges. The apertures 52 are adapted to receive a portion of the pins disposed through the third and the apertures 44c, 44d of the mount 22 to releasably couple the cutting member 24 to the mount 22. It is understood that any number of apertures 52 may be formed in the edge 51 of the cutting member 24, as desired. It is also understood that the edges of the apertures 52 may have any shape, as desired. In the embodiment shown the cutting member 24 is formed from steel and has a substantially trapezoidal shape. It is understood that the cutting member 24 may be formed from any conventional material and may have any shape, as desired.

As shown in FIGS. 1 and 2, the retainer 26 has an aperture 58 formed therethrough. The retainer 26 is coupled to the mount 22 and is slidably disposed in the hollow interior 36 of the housing 20 of the shearing device 10. A means for securing (not shown) is disposed through the aperture 58 of the retainer 26 and in the aperture 44b of the mount 22 to couple the mount 22 and the retainer 26 together. The retainer 26 is partially disposed over the slot 46 formed in the mount 22 to secure the cutting member 24 in place and to militate against an upward movement thereof. In the embodiment shown, the retainer 26 is formed from 4140 steel and has a substantially rectangular shape. It is understood that the retainer 26 may be formed from any conventional material such as aluminum or a polymer for example, and may have any shape, as desired.

During operation, when the cutting member 24 and the mount 22 are in a retracted position, the cutting member 24 is housed completely in the hollow interior 36 of the housing 20. When the actuator 18 is engaged, the actuator arm 34 is caused to move linearly toward the nests 16 and the hose to be sheared. Since the actuator arm 34 is coupled to the mount 22, the mount 22 and the cutting member 24 are also caused to move linearly toward the hose to be sheared. The guides 23 coupled to the mount 22 militate against contact between the housing 20 and the mount 22. The guides 23 are also adapted to provide stability to the mount 22 and facilitate a smooth and guided movement of the mount 22 through the hollow interior 36 of the housing 20. The cutting member 24 is caused to slidably move through a slot formed between the nest 16 coupled to the first body half 38 of the housing 20 and the nest 16 coupled to the second half 39 of the housing 20 until the front of the mount 22 contacts a portion of the nests 16 that form a front edge of the hollow interior 36 of the housing 20.

Once the cutting member 24 enters the aperture 17 formed in the nests 16, the cutting edge 50 contacts the hose to be sheared. As the cutting member 24 shears the hose, the first bevel 54 of the cutting member 24 contacts the hose and provides a force on the hose to begin the shearing operation. Because the first bevel 54 is shorter in length than the second bevel 56, a force applied to the first bevel 54 of the cutting member 24 by the hose and by the actuator 18 is minimized, thereby extending the useful life of the cutting edge 50 and the cutting member 24. After the first bevel 54 has contacted the hose and imparted the force thereon, the second bevel 56 contacts the hose and completes the shearing operation to completely sever the hose. Also, because the first bevel 54 is shorter than the second bevel 56, and because the shearing operation is completed by both the first bevel 54 and the second bevel 56, a deformation of the hose caused by the cutting member 24 during the shearing operation is militated against. Additionally, the amount of hose sheared off as waste is minimized. During a typical shearing operation by the shearing device 10, the hose sheared off as waste is typically less than a length equal to an inner diameter of the hose.

As the cutting member 24 contacts and imparts a force on the hose, the hose may be caused to slightly deform and may move upwardly. Because the circular edges 32 of the nests 16 form an arc greater than 180°, the circular edges 32 militate against the upward movement of the hose during the shearing operation.

To replace the cutting member 24 of the shearing device 10, power to the actuator 18 is disconnected and the top plate 40 of the housing 20 is removed. Next, the means for securing disposed through the retainer 26 is removed and the retainer 26 is uncoupled from the mount 22. The cutting member 24 is then pulled upwardly to disengage the apertures 52 of the cutting member 24 from the pins disposed through the apertures 44c, 44d of the mount 22. A new cutting member 24 can then be placed in the mount 22. The retainer 26 is re-coupled to the mount 22, and the top plate 40 of the housing 20 is re-attached. Accordingly, because only the top plate 40 of the housing 20 and the retainer 26 are removed to replace the cutting member 24, the amount of time required to replace the cutting member 24 is minimized. Additionally, because the cutting member 24 is pulled upwardly during removal from the mount, the hands and fingers of the user are not in contact with or adjacent to the cutting edge 50 of the cutting member 24, thereby minimizing incidents of injury to the user.

From the foregoing description, one ordinarily skilled in the art can easily ascertain the essential characteristics of this invention and, without departing from the spirit and scope thereof, can make various changes and modifications to the invention to adapt it to various usages and conditions in accordance with the scope of the appended claims.

What is claimed is:

1. A hose shearing device comprising:
a housing adapted to receive a portion of a hose therein;
a mount slidably disposed in said housing;
a cutting member releasably mounted to said mount;
an actuator operatively coupled to said mount to slidably move said mount in said housing and cause said cutting member to engage the hose;
a retainer removably coupled to said mount to facilitate removal of said cutting member.

2. The hose shearing device of claim 1, wherein said actuator is one of a hydraulic cylinder, a pneumatic cylinder, a mechanical driving member, and an electrical driving member.

3. The hose shearing device of claim 1, further comprising a guide disposed adjacent said mount adapted to minimize friction between said mount and said housing as said mount is slidably moved therein.

4. The hose shearing device of claim 3, wherein said guide is formed from a polymer.

5. The hose shearing device of claim 1, wherein the housing includes a nest adapted to receive the portion of the hose.

6. The hose shearing device of claim 5, wherein the nest includes an aperture having a curvilinear edge adapted to militate against an upward movement of the hose disposed therein.

7. The hose shearing device of claim 6, wherein the curvilinear edge forms an arc having an angle greater than 180°.

8. The hose shearing device of claim 1, wherein said mount further includes a slot and a pin disposed through the slot adapted to receive a portion of said cutting member.

9. The hose shearing device of claim 8, wherein said cutting member includes an aperture adapted to receive the pin of said mount.

10. The hose shearing device of claim 1, wherein a cutting edge of said cutting member includes a first bevel and a second bevel.

11. The hose shearing device of claim 10, wherein the first bevel has a length and the second bevel has a length greater than the length of the first bevel.

12. A hose shearing device comprising:
a housing including a nest adapted to receive a portion of a hose therein;
a mount slidably disposed in said housing;
a cutting member releasably mounted to said mount;
an actuator operatively coupled to said mount to slidably move said mount in said housing and cause said cutting member to engage the hose;
a retainer removably coupled to said mount, wherein said retainer militates against removal of said cutting member when said guide is coupled to said mount and facilitates removal of said cutting member when removed from said mount.

13. The hose shearing device of claim 12, further comprising a guide disposed adjacent said mount adapted to minimize friction between said mount and said housing as said mount is slidably moved therein.

14. The hose shearing device of claim 12, wherein the nest includes an aperture having a curvilinear edge adapted to militate against an upward movement of the hose disposed therein.

15. The hose shearing device of claim 14, wherein the curvilinear edge forms an arc having an angle greater than 180°.

16. The hose shearing device of claim 12, wherein said mount further includes a slot and a pin disposed through the slot adapted to receive a portion of said cutting member.

17. The hose shearing device of claim 12, wherein said cutting member includes an aperture adapted to receive the pin of said mount.

18. The hose shearing device of claim 12, wherein a cutting edge of said cutting member includes a first bevel and a second bevel.

19. The hose shearing device of claim 18, wherein the first bevel has a length and the second bevel has a length greater than the length of the first bevel.

20. A hose shearing device comprising:
a housing including a nest adapted to receive a portion of a hose therein;
a mount slidably disposed in said housing;
a cutting member having a cutting edge forming a first bevel and a second bevel releasably mounted to said mount;
an actuator operatively coupled to said mount to slidably move said mount in said housing and cause said cutting member to engage the hose;
a retainer removably coupled to said mount, wherein said retainer militates against removal of said cutting member when said guide is coupled to said mount and facilitates removal of said cutting member when removed from said mount.
